(19) United States
(12) Patent Application Publication
(10) Pub. No.: US 2023/0383197 A1
(43) Pub. Date: Nov. 30, 2023

(54) SLURRY-PHASE CATALYST COMPOSITIONS IN AROMATIC SOLVENTS AND METHODS OF MAKING

(71) Applicant: Saudi Arabian Oil Company, Dhahran (SA)

(72) Inventors: Omer Refa Koseoglu, Dhahran (SA); Ashok Kumar Punetha, Dhahran (SA)

(73) Assignee: Saudi Arabian Oil Company, Dhahran (SA)

(21) Appl. No.: 17/828,463

(22) Filed: May 31, 2022

(51) Int. Cl. C10G 47/02; B01J 31/22; B01J 31/02; B01J 35/12; B01J 37/04

(52) U.S. Cl. CPC C10G 47/02; B01J 31/2213; B01J 31/02; B01J 35/12; B01J 37/04; C10G 2300/703; B01J 2531/64; B01J 2531/90

(57) ABSTRACT

This disclosure relates to catalyst compositions comprising a metal complex and aromatic bottoms comprising C₉+ hydrocarbons, methods of forming catalyst compositions, and methods of hydrocracking petroleum compositions.

### FIELD

Embodiments disclosed herein generally relate to hydrocarbon processing, and more specifically to catalyst compositions for hydrocarbon processing.

### TECHNICAL BACKGROUND

Catalytic reformers are used in refineries to produce reformate, which can be used as an aromatic rich gasoline blending fraction, or can be used as feedstock to produce aromatics, also referred to as benzene, toluene, and xylene (BTX). The reformate fraction can be further treated to reduce the aromatics content. Treatment options available include benzene hydrogenation and aromatics extraction. In benzene hydrogenation, the reformate is selectively hydrogenated to reduce the benzene content, and the total aromatics content is reduced by blending if needed. In aromatics extraction, the reformate is sent to an aromatic recovery complex to extract the aromatics, such as benzene, toluene and xylenes, which have a premium chemical value, and to produce an aromatics and benzene free gasoline blending component. The aromatics recovery complex produces an aromatic bottoms stream that is not suitable as a gasoline blending component.

### SUMMARY

An aromatic bottoms stream is produced as a by-product from an aromatics recovery complex. However, this results in an additional product that must be disposed of or processed accordingly. Additionally, rising demand for transportation fuels and increasing stocks of high sulfur residual oil have resulted in a renewed interest in the processing of heavy residue to generate useful lighter fuels and chemicals. Residual oils are of low quality because of the presence of impurities like Conradson carbon residue (CCR), asphaltenes, sulfur, nitrogen, and heavy metals. Fixed-bed and ebullated-bed technologies are limited in processing these residual oils with high metal content. For instance, ebullated-bed reaction technologies may achieve conversion of up to 65% by volume, but is limited to feedstock with a metal content below 400 parts per million by weight (ppmw). Alternatively, slurry-phase hydrocracking technology has gained attention in recent years due to its flexibility to process heavier feedstock with high metal content to achieve high conversion rates. Slurry-phase hydrocracking technologies may process residual oils containing up to 4,000 ppm of metals and achieve conversion of up to 95% by volume. Therefore, an ongoing need exists for the conversion of aromatic bottoms stream to a useful material for the reduction in waste production while at the same time improving economic viability of slurry-phase hydrocracking.

According to at least one aspect of the present disclosure, a method of forming a catalyst composition comprises mixing a metal complex and aromatic bottoms, where the aromatic bottoms is a product from an aromatics recovery complex which comprises C₉₊ aromatic compounds; heating the mixture of the metal complex and aromatic bottoms to an elevated temperature sufficient to dissolve or disperse at least a portion of the metal complex in the aromatic bottoms, thereby forming a catalyst precursor composition comprising a liquid component and a solid component; and separating out at least a portion of the solid component from the catalyst precursor composition to produce the catalyst composition comprising the liquid component.

According to at least one aspect of the present disclosure, a catalyst composition comprising a transition metal complex and an aromatic bottoms comprising C₉₊ aromatics; wherein the transition metal complex is dissolved or dispersed in the aromatic bottoms.

This summary is provided to introduce a selection of concepts that are further described in the detailed description. This summary is not intended to identify key or essential features of the claimed subject matter, nor is it intended to be used as an aid in limiting the scope of the claimed subject matter.

Additional features and advantages of the described embodiments will be set forth in the detailed description that follows. The additional features and advantages of the described embodiments will be, in part, readily apparent to those skilled in the art from that description or recognized by practicing the described embodiments, including the detailed description that follows as well as the drawings and the claims.

### DESCRIPTION OF DRAWINGS

FIG. 1 is a generalized schematic diagram of an aromatics recovery complex.

FIG. 2 is a generalized schematic diagram of a method for making a slurry-phase catalyst composition, according to one or more embodiments described herein.

FIG. 3 is FTIR spectra, according to one or more embodiments described herein.

Reference will now be made in greater detail to various embodiments, some embodiments of which are illustrated in the accompanying drawings.

### DETAILED DESCRIPTION

The present disclosure is directed to catalyst compositions, methods of producing catalyst compositions, and methods of hydrocracking using catalyst compositions. The catalyst compositions of the present disclosure include a metal complex and an aromatic bottoms comprising C₉+ aromatics. In embodiments, the aromatic bottoms can be a product from an aromatics recovery complex (ARC), which can produce more valuable chemical intermediates, such as catalysts, for example, while reducing waste production.

In one or more embodiments, a method of producing a catalyst composition can include mixing a metal complex and aromatic bottoms to form a mixture. The aromatic bottoms can be a product from an ARC, which comprises C₉+ aromatics. The mixture of the metal complex and aromatic bottoms can be heated to an elevated temperature sufficient to dissolve or disperse at least a portion of the metal complex in the aromatic bottoms to form a catalyst precursor composition. The catalyst precursor composition can include both a liquid component and a solid component. At least a portion of the solid component can be separated out from the catalyst precursor composition to produce the catalyst composition comprising the liquid component.

As used herein, the term “catalyst” can refer to any substance which increases the rate of a specific chemical reaction. Catalysts described in this disclosure can be utilized to promote various reactions, such as cracking of hydrocarbons. Some catalysts can have multiple forms of catalytic activity, and calling a catalyst by one particular function does not render that catalyst incapable of being catalytically active for other functionality.

As used herein, the term, “cracking” generally refers to a chemical reaction where a molecule having carbon-carbon bonds is broken into more than one molecule by the breaking of one or more of the carbon-carbon bonds; where a compound including a cyclic moiety, such as an aromatic compound, is first hydrogenated and then converted to a compound that does not include a cyclic moiety; or where a molecule having carbon-carbon double bonds are reduced to carbon-carbon single bonds. As used herein, the term, “hydrocracking” generally refers to a cracking process that occurs by the addition of hydrogen.

As used herein, the term “homogenous catalyst” can refer to a catalyst used in catalysis reactions where the catalyst is in the same phase as the reactants, which may be in a solution. As used herein, the term “dispersed catalyst” can refer to a catalyst used in catalysis reactions where the catalyst and the reactants are in different phases. As used herein, the term “catalyst composition” can refer to a catalyst operable to increase a reaction rate in a slurry-phase unit, which may include a slurry-phase hydrocracking unit.

As used herein, the term “aromatics recovery complex” (ARC) refers to a system operable to separate aromatics from a stream, such as but not limited to, a reformate stream. The reformate stream can be a stream from a catalyst reforming unit. Aromatics from any other source can be sent to an aromatics recovery complex. Additionally, a stream comprising aromatics can be pretreated or processed to remove impurities before sending the stream to the aromatics recovery complex. For instance, if the stream contains a high concentration of olefins and diolefins, the stream can be treated to reduce the concentration of the olefins and diolefins before sending the stream to the aromatics recovery complex.

As used herein, the term “mixing vessel” can refer to any tank, reservoir, or structure operable to contain aromatic bottoms, a metal complex, or other catalyst precursor materials, including but not limited to solvents and additives. The mixing vessel can comprise a mixing device operable to mix the contents of the mixing vessel. The mixing vessel can also contain a heating element operable to heat the contents of the mixing vessel.

As used herein, the term “slurry-phase hydrocracking unit” can refer to a technology that can process residual oils in the presence of slurry or homogeneous catalysts. Benefits of slurry-phase hydrocracking over other technologies can include the ability to process residual oils with a boiling point greater than 400° C., greater than 450° C., greater than 500° C., greater than 520° C., or even greater than 565° C. Further, slurry-phase hydrocracking can be used to process residual oils with a Conradson carbon residue (CCR) concentration greater than 10 weight percent (wt. %), 15 wt. %, 20 wt. %, or even 25 wt. % Slurry-phase hydrocracking can be used to achieve a conversion level as high as 95 volume percent. The catalyst can play a significant role in slurry-phase hydrocracking. A catalyst with greater activity can result in greater yield of light fuel oil and reduced yield of coke. Two types of catalysts for slurry-phase hydrocracking include heterogeneous solid powder catalysts and homogeneous catalysts. However, the former, such as hematite, lignite coke, and red mud are less desirable because of the difficulty in separation and equipment wear caused by the high dosages of these catalysts. Some slurry-phase catalysts can be formulated as water-soluble catalysts or oil-soluble catalysts. Slurry-phase catalysts can include metal compounds, and the metal can be selected from elements of IUPAC groups 4-10 among which may include, among others, molybdenum, nickel, cobalt, tungsten, iron and chromium. The slurry-phase catalyst and feedstock oil can be added into a reactor simultaneously, added separately, or combined and then added to the reactor.

As used herein, a “reactor” refers to any vessel, container, or the like, in which one or more chemical reactions can occur between one or more reactants optionally in the presence of one or more catalysts. For example, a reactor may include a tank or tubular reactor configured to operate as a batch reactor, a continuous stirred-tank reactor (CSTR), or a plug flow reactor. Example reactors include packed bed reactors such as fixed bed reactors, and fluidized bed reactors. One or more “reaction zones” may be disposed within a reactor. As used in this disclosure, a “reaction zone” refers to an area in which a particular reaction takes place in a reactor. For example, a packed bed reactor with multiple catalyst beds can have multiple reaction zones, in which each reaction zone is defined by the area of each catalyst bed.

As used herein, a “separation unit” refers to any separation device that at least partially separates one or more chemicals in a mixture from one another. For instance, a separation unit may selectively separate different chemical species from one another, forming one or more chemical fractions. Examples of separation units include, without limitation, distillation columns, fractionators, flash drums, knock-out drums, knock-out pots, centrifuges, filtration devices, traps, scrubbers, expansion devices, membranes, solvent extraction devices, high-pressure separators, low-pressure separators, and the like. It should be understood that separation processes described in this disclosure may not completely separate all of one chemical constituent from all of another chemical constituent. It should be understood that the separation processes described in this disclosure “at least partially” separate different chemical components from one another, and that even if not explicitly stated, it should be understood that separation may include only partial separation. As used in this disclosure, one or more chemical constituents may be “separated” from a process stream to form a new process stream. Generally, a process stream may enter a separation unit and be divided or separated into two or more process streams of desired composition.

As used herein, the term “ligands” can refer to any ion or molecule that binds to a central atom to form a coordination complex. The ligands may be bound to a central metal atom to form a catalyst precursor or a catalyst. Examples of ligands include, without limitation, iodide, bromide, sulfide, thiocyanate, chloride, nitrate, azide, fluoride, hydroxide, oxalate, water, nitrite, isothiocyanate, acetonitrile, pyridine, ammonia, ethylenediamine, 2,2′-bipyridine, 1,10-phenanthroline, nitrile, triphenylphosphine, cyanide, carbon monoxide, acetylacetonate, and organometallic compounds where the metal is bonded to a carbon atom.

As used herein, the term “fluid” can include liquids, gases, or both.

When used to describe certain carbon atom-containing chemical groups, an expression having the form “Cₓ-C_{y}” means that the unsubstituted form of the chemical group has from x carbon atoms to y carbon atoms, inclusive of x and y. For instance, a C₅-C₆ hydrocarbon is a hydrocarbon having from 5 to 6 carbon atoms in its unsubstituted form.

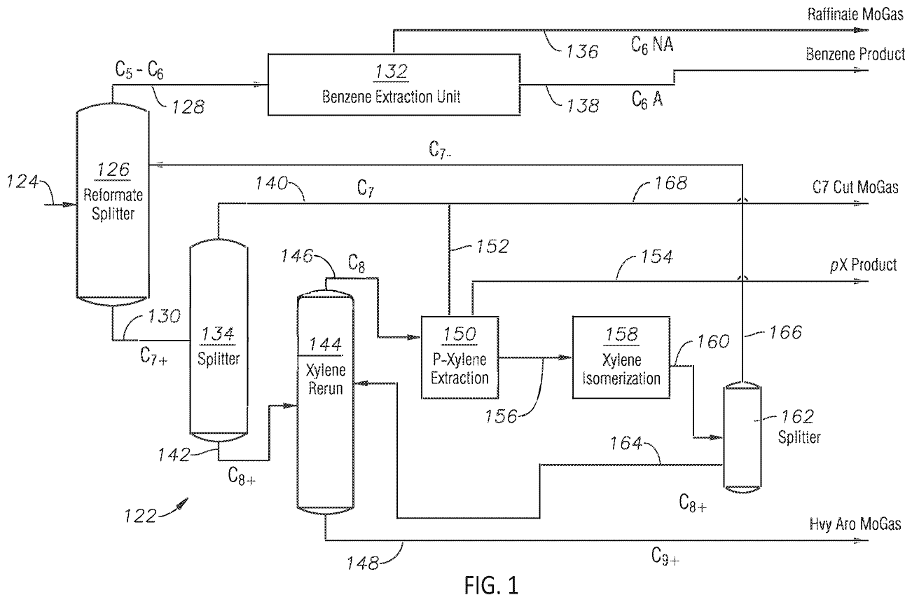

Referring to FIG. 1, a schematic of a conventional aromatics recovery complex (ARC) 122 is shown. Reformate stream 124 from a catalytic reforming unit can be split into two fractions: light reformate stream 128 with C₅-C₆ hydrocarbons, and heavy reformate stream 130 with C₇₊ hydrocarbons. A reformate splitter 126 can separate reformate stream 124. The light reformate stream 128 can be sent to a benzene extraction unit 132 to extract the benzene as benzene product in stream 138, and to recover substantially benzene-free gasoline in raffinate motor gasoline (mogas) stream 136. The heavy reformate stream 130 can be sent to a splitter 134 which produces a C₇ cut mogas stream 140 and a C₈₊ hydrocarbon stream 142.

Still referring to FIG. 1, a xylene rerun unit 144 can separate C₈₊ hydrocarbons into C₈ hydrocarbon stream 146 and C₉₊ (heavy aromatic mogas) hydrocarbon stream 148. C₈ hydrocarbon stream 146 can proceed to p-xylene extraction unit 150 to recover p-xylene in p-xylene product stream 154. In other embodiments, the C₈ hydrocarbon stream 146 can proceed to a p-xylene separation unit to separate p-xylene from the p-xylene product stream 154 (not pictured). In embodiments, the p-xylene extraction unit 150 can include one or more solvents and/or may include extractive distillation columns. In embodiments, the p-xylene separation unit can include adsorbent columns. P-xylene extraction unit 150, and/or p-xylene separation unit can produce a C₇ cut mogas stream 152, which can be combined with C₇ cut mogas stream 140 to produce C₇ cut mogas stream 168. Other xylenes can be recovered and can be sent to xylene isomerization unit 158 by stream 156 to convert xylenes in stream 156 to p-xylene. The isomerized xylenes can be sent to splitter 162 by stream 160. The converted fraction can be recycled back to p-xylene extraction unit 150 from splitter 162 by way of streams 164 and 146. Splitter top stream 166 can be recycled back to reformate splitter 126. The heavy fraction from the xylene rerun unit 144 can be recovered as an aromatic bottoms stream (shown as C₉₊ and Hvy Aro MoGas in FIG. 1 at stream 148). In embodiments, the C₉₊ stream can be supplied to a transalkylation unit to produce a C₁₁₊ stream (not pictured).

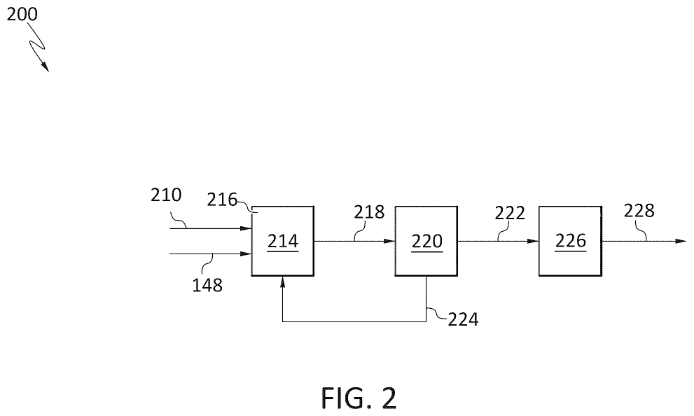

Referring now to FIG. 2, a method of producing a catalyst composition 200 is schematically depicted that includes combining a metal complex 210 and aromatic bottoms, such as the aromatic bottoms stream 148 of FIG. 1, in a mixing vessel 214, thereby forming a mixture 216. The mixture 216 can be heated in the mixing vessel 214 to an elevated temperature sufficient to dissolve at least a portion of the metal complex 210 in the aromatic bottoms stream 148 to form a catalyst precursor composition 218. In embodiments, the mixture 216 can be transferred to a separate heating vessel (not pictured) and heated to an elevated temperature sufficient to dissolve at least a portion of the metal complex 210 in the aromatic bottoms stream 148 to form a catalyst precursor composition 218. In embodiments, at least a portion of the catalyst precursor composition 218 can be transferred to a slurry-phase hydrocracking unit 226 to form a slurry-phase catalyst stream 228 (not pictured).

In embodiments, the catalyst precursor composition 218 can be transferred to a separation unit 220 where a liquid component and a solid component of the catalyst precursor composition 218 can be at least partially separated to produce a catalyst composition 222 and a separated solid component 224. In embodiments, the catalyst composition 222 can include a portion of the solid component. In embodiments, the portion of the solid component is dispersed in the catalyst composition 222. In embodiments, the catalyst composition 222 can be transferred to a slurry-phase hydrocracking unit 226 to form a slurry-phase catalyst stream 228. In embodiments, the separated solid component 224 can be transferred to the mixing vessel 214 comprising the metal complex 210 and the aromatic bottoms stream 148 to recycle the separated solid component 224. In other embodiments, the metal complex 210 can be mixed with the aromatic bottoms at or below the solubility limit of the aromatic bottoms. In such embodiments, the separated solid component 224 is not transferred to the mixing vessel 214.

In embodiments, the metal complex 210 can comprise one or more transition metals selected from elements of IUPAC groups 4-10, including but not limited to, molybdenum, cobalt, nickel, tungsten, iron, chromium, or a combination of two or more thereof. In embodiments, the metal complex 210 can comprise one or more transition metals selected from the group consisting of molybdenum, cobalt, nickel, tungsten, iron, chromium and a combination of two or more thereof. Without being bound by any particular theory, it is believed that the presence of one or more transition metals in the metal complex 210 can improve the catalytic activity of the catalyst precursor composition 218, the catalyst composition 222, or both the catalyst precursor composition 218 and the catalyst composition 222.

In embodiments, the metal complex 210 can comprise ligands, organometallics, salts, oxides, sulfides, or a combination of two or more thereof. In embodiments, the metal complex 210 can comprise an organometallic molybdenum hexacarbonyl. In embodiments, the metal complex 210 can comprise a metal oxide. For instance, in embodiments the metal oxide is molybdenum trioxide. In embodiments, the metal complex 210 can comprise a metal with ligands comprising oxygen groups, wherein the oxygen groups are bonded to the metal. For instance, in embodiments, the metal complex 210 can comprise bis(acetylacetonato)dioxomolybdenum(VI). In embodiments, the metal complex 210 is bis(acetylacetonato)dioxomolybdenum(VI). In embodiments, the metal complex 210 can comprise bis(acetylacetonato)dioxomolybdenum(VI), molybdenum trioxide, molybdenum hexacarbonyl, or a combination of two or more thereof. In embodiments, the metal complex 210 can be selected from the group consisting of bis(acetylacetonato)dioxomolybdenum(VI), molybdenum trioxide, molybdenum hexacarbonyl, and a combination of two or more thereof.

In embodiments, the aromatic bottoms can be a product of an ARC, such as aromatic bottoms stream 148. In embodiments, the aromatic bottoms can comprise aromatic compounds of C₉₊ hydrocarbon chains that may be straight, branched, or cyclic, and the chains may be saturated or unsaturated. The aromatic compounds can include alkyl groups. For instance, the aromatic bottoms can include, but not be limited to, monoaromatics, diaromatics, triaromatics, tetraaromatics, pentaaromatics, or combinations thereof. The aromatic bottoms can include naptheno aromatics. In embodiments, the aromatic bottoms can include monoaromatics in an amount greater than 30 wt. %, greater than 40 wt. %, greater than 50 wt. %, or even greater than 60 wt. % based on the total weight of the aromatic bottoms. The aromatic bottoms can include monoaromatics in an amount from 30 wt. % to 90 wt. %, from 30 wt. % to 80 wt. %, from 30 wt. % to 70 wt. %, from 40 wt. % to 90 wt. %, from 40 wt. % to 80 wt. %, from 40 wt. % to 70 wt. %, from 50 wt. % to 90 wt. %, from 50 wt. % to 80 wt. %, from 50 wt. % to 70 wt. %, from 60 wt. % to 90 wt. %, from 60 wt. % to 80 wt. %, or from 60 wt. % to 70 wt. %. In embodiments, the aromatic bottoms can have a Hildebrand solubility parameter of greater than or equal to 21 MPa^{1/2}, greater than or equal to 22 MPa^{1/2}, or even greater than or equal to 23 MPa^{1/2}.

In embodiments, the aromatic bottoms can include sulfur in an amount less than 100 parts per million by weight (ppmw), less than 50 ppmw, or even less than 10 ppmw. In embodiments, the aromatic bottoms can include sulfur in an amount of from 0 ppmw to 100 ppmw, from 0 ppmw to 50 ppmw, from 0 ppmw to 10 ppmw, from 10 ppmw to 100 ppmw, or from 10 ppmw to 50 ppmw based on the total weight of the aromatic bottoms. In embodiments, the aromatic bottoms can include nitrogen in an amount less than 100 ppmw, less than 50 ppmw, or even less than 10 ppmw. In embodiments, the aromatic bottoms can include nitrogen in an amount of from 0 ppmw to 100 ppmw, from 0 ppmw to 50 ppmw, from 0 ppmw to 10 ppmw, from 10 ppmw to 100 ppmw, or from 10 ppmw to 50 ppmw based on the total weight of the aromatic bottoms.

In embodiments, the aromatic bottoms can have a boiling point range of from 100° C. to 450° C. For instance, the aromatic bottoms can have a boiling point range of from 100° C. to 400° C., from 100° C. to 350° C., from 100° C. to 300° C., from 100° C. to 250° C., from 100° C. to 200° C., from 100° C. to 250° C., from 150° C. to 450° C., from 150° C. to 400° C., from 150° C. to 350° C., from 150° C. to 300° C., from 150° C. to 250° C., from 150° C. to 200° C., from 200° C. to 450° C., from 200° C. to 400° C., from 200° C. to 350° C., from 200° C. to 300° C., from 200° C. to 250° C., from 250° C. to 450° C., from 250° C. to 400° C., from 250° C. to 350° C., from 250° C. to 300° C., from 300° C. to 450° C., from 300° C. to 400° C., or from 300° C. to 350° C.

In embodiments, the metal complex 210 and the aromatic bottoms can be mixed in the mixing vessel 214 that can comprise a mixing device to form the mixture 216. In embodiments, the metal complex 210 and the aromatic bottoms can be at least partially combined and then transferred to the mixing vessel 214 to form the mixture 216.

In embodiments, the mixture 216 can comprise from 100 parts per million by weight (ppmw) to 100,000 ppmw of the metal complex 210. For instance, the mixture 216 can comprise from 100 ppmw to 10,000 ppmw, from 100 ppmw to 50,000 ppmw, from 100 ppmw to 100,000 ppmw, from 1,000 ppmw to 10,000 ppmw, from 1,000 ppmw to 50,000 ppmw, from 1,000 ppmw to 100,000 ppmw, from 5,000 ppmw to 10,000 ppmw, from 5,000 ppmw to 50,000 ppmw, or from 5,000 ppmw to 100,000 ppmw of the metal complex 210.

In embodiments, the mixture 216 of the metal complex 210 and the aromatic bottoms can be heated from 50° C. to 250° C. For instance, the catalyst composition precursor 216 can be heated from 50° C. to 75° C., from 50° C. to 100° C., from 50° C. to 125° C., from 50° C. to 150° C., from 50° C. to 175° C., from 50° C. to 200° C., from 50° C. to 250° C., from 75° C. to 100° C., from 75° C. to 125° C., from 75° C. to 150° C., from 75° C. to 175° C., from 75° C. to 200° C., from 75° C. to 250° C., from 100° C. to 125° C., from 100° C. to 150° C., from 100° C. to 175° C., from 100° C. to 200° C., from 100° C. to 250° C., from 125° C. to 150° C., from 125° C. to 175° C., from 125° C. to 200° C., from 125° C. to 250° C., from 150° C. to 175° C., from 150° C. to 200° C., from 150° C. to 250° C., from 175° C. to 200° C., or from 175° C. to 250° C. Without being bound by any particular theory, it is believed that at temperatures below 50° C., the metal complex 210 of the catalyst composition precursor 216 may be insoluble, or only slightly soluble in the aromatic bottoms 212. Additionally, it is believed that at temperatures above 250° C. the metal complex 210 may decompose.

In embodiments, the mixing vessel 214 can be heated from 50° C. to 250° C. For instance, the mixing vessel 214 can be heated from 50° C. to 75° C., from 50° C. to 100° C., from 50° C. to 125° C., from 50° C. to 150° C., from 50° C. to 175° C., from 50° C. to 200° C., from 50° C. to 250° C., from 75° C. to 100° C., from 75° C. to 125° C., from 75° C. to 150° C., from 75° C. to 175° C., from 75° C. to 200° C., from 75° C. to 250° C., from 100° C. to 125° C., from 100° C. to 150° C., from 100° C. to 175° C., from 100° C. to 200° C., from 100° C. to 250° C., from 125° C. to 150° C., from 125° C. to 175° C., from 125° C. to 200° C., from 125° C. to 250° C., from 150° C. to 175° C., from 150° C. to 200° C., from 150° C. to 250° C., from 175° C. to 200° C., or from 175° C. to 250° C. Without being bound by any particular theory, it is believed that at temperatures below 50° C., the metal complex 210 of the mixture 216 may be insoluble, or only slightly soluble in the aromatic bottoms 212. Additionally, it is believed that at temperatures above 250° C. the metal complex 210 may decompose.

In embodiments, the mixture 216 can be pressurized from 100 kilopascals (kPa) to autogenous pressure in the mixing vessel 214, in a separate heating vessel, or in combination thereof. For instance, the mixture 216 can be pressurized from 1 bar to 500 kPa, from 100 kPa to 1,000 kPa, from 100 kPa to 1,500 kPa, from 100 kPa to 2,000 kPa, from 100 kPa to 4,000 kPa, from 100 kPa to 6,000 kPa, from 100 kPa to 8,000 kPa, from 500 kPa to 1,000 kPa, from 500 kPa to 1,500 kPa, from 500 kPa to 2,000 kPa, from 500 kPa to 4,000 kPa, from 500 kPa to 6,000 kPa, from 500 kPa to 8,000 kPa, from 1,000 kPa to 1,500 kPa, from 1,000 kPa to 2,000 kPa, from 1,000 kPa to 4,000 kPa, from 1,000 kPa to 6,000 kPa, from 1,000 kPa to 8,000 kPa, from 1,500 kPa to 2,000 kPa, from 1,500 kPa to 4,000 kPa, from 1,500 kPa to 6,000 kPa, from 1,500 kPa to 8,000 kPa, or from 100 kPa to autogenous pressure. Without being bound by any particular theory, it is believed that the increased pressure of the mixture 216 can result in a higher concentration of the metal complex 210 in the catalyst precursor composition 218.

In embodiments, the catalyst precursor composition 218 can comprise from 100 parts per million by weight (ppmw) to 6,000 ppmw of the metal complex 210. For instance, the catalyst precursor composition 218 can comprise from 100 ppmw to 1,000 ppmw, from 100 ppmw to 2,000 ppmw, from 100 ppmw to 3,000 ppmw, from 100 ppmw to 4,000 ppmw, from 100 ppmw to 5,000 ppmw, from 100 ppmw to 6,000 ppmw, from 1,000 ppmw to 2,000 ppmw, from 1,000 ppmw to 3000 ppmw, from 1,000 ppmw to 4,000 ppmw, from 1000 ppmw to 5,000 ppmw, from 1,000 ppmw to 6,000 ppmw, from 2,000 ppmw to 3,000 ppmw, from 2,000 ppmw to 4,000 ppmw, from 2,000 ppmw to 5,000 ppmw, from 2,000 ppmw to 6,000 ppmw, from 3,000 ppmw to 4,000 ppmw, from 3,000 ppmw to 5,000 ppmw, from 3,000 ppmw to 6,000 ppmw, from 4,000 ppmw to 5,000 ppmw, from 4,000 ppmw to 6,000 ppmw, or from 5,000 ppmw to 6,000 ppmw of the metal complex 210. In embodiments, the catalyst precursor composition 218 can comprise a concentration of the metal complex 210 that may be greater than a solubility limit of the metal complex 210. Without being bound by any particular theory, it is believed that at concentrations below 100 ppmw, there may be an insufficient amount of the metal complex 210 present in the catalyst precursor composition 218 for a catalytic reaction to proceed at a viable rate. On the contrary, it is believed that at concentrations above 6000 ppmw, there may be a greater portion of the metal complex 210 out of solution in the catalyst precursor composition 218, which can increase operational costs.

In embodiments, at least a portion of the metal complex 210 can be dissolved in the catalyst precursor composition 218. For instance, in some embodiments, at least 0.1 weight percent (wt. %), at least 0.5 wt. %, at least 1 wt. %, at least 2 wt. %, at least 3 wt. %, at least 4 wt. %, at least 5 wt. %, at least 10 wt. %, at least 20 wt. %, at least 30 wt. %, at least 40 wt. %, at least 50 wt. %, at least 60 wt. %, at least 70 wt. %, at least 80 wt. %, at least 90 wt. %, at least 95 wt. %, or even at least 99 wt. of the metal complex 210 can be dissolved in the catalyst precursor composition 218. Without being bound by any particular theory, it is believed that a greater percentage of the metal complex 210 dissolved in the aromatic bottoms can improve catalytic function of the catalyst precursor composition 218. Additionally, it is believed that a greater percentage of the metal complex 210 dissolved in the catalyst precursor composition 218 can improve the economics of the method of forming the catalyst composition 222.

In embodiments, at least a portion of the metal complex 210 can be dispersed in the catalyst precursor composition 218. For instance, in some embodiments, at least 0.1 weight percent (wt. %), at least 0.5 wt. %, at least 1 wt. %, at least 2 wt. %, at least 3 wt. %, at least 4 wt. %, at least 5 wt. %, at least 10 wt. %, at least 20 wt. %, at least 30 wt. %, at least 40 wt. %, at least 50 wt. %, at least 60 wt. %, at least 70 wt. %, at least 80 wt. %, at least 90 wt. %, at least 95 wt. %, or even at least 99 wt. of the metal complex 210 can be dispersed in the catalyst precursor composition 218. Without being bound by any particular theory, it is believed that a greater percentage of the metal complex 210 dispersed in the catalyst precursor composition 218 can improve catalytic function of the catalyst precursor composition 218 in slurry-phase hydrocracking. For instance, in embodiments where the metal complex 210 has reduced solubility in the aromatic bottoms, an increased amount of the metal complex 210 can be dispersed in the catalyst precursor composition 218, which can improve catalytic function in slurry-phase hydrocracking.

In embodiments, the catalyst precursor composition 218 can comprise a liquid component and a solid component. In embodiments, the catalyst precursor composition 218 can be transferred to a separation unit 120 where a liquid component and a solid component of the catalyst precursor composition 218 are at least partially separated to form a catalyst composition 222 and a separated solid component 224. In embodiments, the separation unit 120 can be a solid settling vessel operable to cause an amount of the solid component of the catalyst precursor composition 218 to settle and an amount of the liquid component to remain in solution. In embodiments, at least a portion of the metal complex 210 is in the catalyst composition 222. In embodiments, the catalyst composition 222 includes a dissolved metal complex 210 and a dispersed metal complex 210. In other embodiments, the catalyst composition 222 includes a dissolved metal complex 210 and does not include a dispersed metal complex 210.

In embodiments, at least a portion of the metal complex 210 can be dissolved in the catalyst composition 222. For instance, in some embodiments, at least 0.1 weight percent (wt. %), at least 5 wt. %, at least 10 wt. %, at least 20 wt. %, at least 30 wt. %, at least 40 wt. %, at least 50 wt. %, at least 60 wt. %, at least 70 wt. %, at least 80 wt. %, at least 90 wt. %, at least 95 wt. %, or even at least 99 wt. of the metal complex 210 can be dissolved in the catalyst composition 222. Without being bound by any particular theory, it is believed that a greater percentage of the metal complex 210 dissolved in the aromatic bottoms can improve catalytic function of the catalyst composition 222. Additionally, it is believed that a greater percentage of the metal complex 210 dissolved in the aromatic bottoms can improve the economics of the method of forming the catalyst composition 222.

In embodiments, at least a portion of the metal complex 210 can be dispersed in the catalyst composition 222. For instance, in some embodiments, at least 0.1 weight percent (wt. %), at least 0.5 wt. %, at least 1 wt. %, at least 2 wt. %, at least 3 wt. %, at least 4 wt. %, at least 5 wt. %, at least 10 wt. %, at least 20 wt. %, at least 30 wt. %, at least 40 wt. %, at least 50 wt. %, at least 60 wt. %, at least 70 wt. %, at least 80 wt. %, at least 90 wt. %, at least 95 wt. %, or even at least 99 wt. of the metal complex 210 can be dispersed in the catalyst composition 222. Without being bound by any particular theory, it is believed that a greater percentage of the metal complex 210 dispersed in the catalyst composition 222 can improve catalytic function of the catalyst composition 222 in slurry-phase hydrocracking.

In embodiments, the separated solid component 224 can be transferred to the mixing vessel 214. Without being bound by any particular theory, it is believed that recycling the separated solid component 224 to the mixing vessel 214 can result in reduced operational cost of the method of forming the catalyst composition 222.

In embodiments, the catalyst composition 222 can be transferred to a slurry-phase hydrocracking unit 226 to form a slurry-phase catalyst stream 228. In embodiments, the catalyst composition 222 can be used to hydrocrack a petroleum composition in the slurry-phase hydrocracking unit 226.

In embodiments, the operating conditions of the slurry-phase hydrocracking unit 226 can include a minimum hydrogen partial pressure from 5,000 kPa (50 bar) to 25,000 kPa (250 bar). For instance, the minimum hydrogen partial pressure can be from 5,000 kPa to 10,000 kPa, from 5,000 kPa to 15,000 kPa, from 5,000 kPa to 20,000 kPa, from 5,000 kPa to 25,000 kPa, from 10,000 kPa to 15,000 kPa, from 10,000 kPa to 20,000 kPa, from 10,000 kPa to 25,000 kPa, from 15,000 kPa to 20,000 kPa, from 15,000 kPa to 25,000 kPa, or from 20,000 kPa to 25,000 kPa.

In embodiments, the operating conditions of the slurry-phase hydrocracking unit 226 can include an operating temperature from 300° C. to 550° C. For instance, the operating temperature can be from 300° C. to 400° C., from 300° C. to 500° C., from 300° C. to 550° C., from 400° C. to 500° C., from 400° C. to 550° C., from 450° C. to 500° C., or from 500° C. to 550° C.

In embodiments, the operating conditions of the slurry-phase hydrocracking unit 226 can include a hydrogen feed rate from 500 standard liters of hydrogen to 1 liter of oil (StLt/L) to 2500 StLt/L. For instance, the hydrogen feed rate can be from 500 StLt/L to 1000 StLt/L, from 500 StLt/L to 1500 StLt/L, from 500 StLt/L to 2000 StLt/L, from 500 StLt/L to 2500 StLt/L, from 1000 StLt/L to 1500 StLt/L, from 1000 StLt/L to 2000 StLt/L, from 1000 StLt/L to 2500 StLt/L, from 1500 StLt/L to 2000 StLt/L, from 1500 StLt/L to 2500 StLt/L, or from 2000 StLt/L to 2500 StLt/L.

In embodiments, the operating conditions of the slurry-phase hydrocracking unit 226 can include a hydrogen consumption rate from 100 StLt/L to 2000 StLt/L. For instance, the hydrogen consumption rate can be from 100 StLt/L to 250 StLt/L, from 100 StLt/L to 500 StLt/L, from 100 StLt/L to 1000 StLt/L, from 100 StLt/L to 1500, from 100 StLt/L to 2000 StLt/L, from 500 StLt/L to 1000 StLt/L, from 500 StLt/L to 1500, from 500 StLt/L to 2000 StLt/L, from 1000 StLt/L to 1500, or from 1000 StLt/L to 2000 StLt/L. In embodiments, the hydrogen feed rate can be approximated by a multiple of the hydrogen consumption rate. For instance, the hydrogen feed rate may be 2 times, 3 times, or even 4 times the hydrogen consumption rate.

In embodiments, the slurry-phase hydrocracking unit can comprise a feedstock having an average boiling temperature of greater than 370° C., greater than 400° C., greater than 450° C., greater than 500° C., or even greater than 520° C. In embodiments, the slurry-phase hydrocracking unit can comprise a feedstock having an average boiling temperature of from 370° C. to 700° C., from 370° C. to 600° C., from 450° C. to 700° C., from 450° C. to 600° C., from 500° C. to 700° C., from 500° C. to 600° C., from 520° C. to 700° C., or from 520° C. to 600° C.

In embodiments, slurry-phase catalyst stream 228 can comprise from 100 parts per million by weight (ppmw) to 10,000 ppmw of the metal complex 210. For instance, the slurry-phase catalyst stream 228 can comprise from 100 ppmw to 1,000 ppmw, from 100 ppmw to 2,000 ppmw, from 100 ppmw to 3,000 ppmw, from 100 ppmw to 4,000 ppmw, from 100 ppmw to 5,000 ppmw, from 100 ppmw to 6,000 ppmw, from 1,000 ppmw to 2,000 ppmw, from 1,000 ppmw to 3,000 ppmw, from 1,000 ppmw to 4,000 ppmw, from 1,000 ppmw to 5,000 ppmw, from 1,000 ppmw to 6,000 ppmw, from 1,000 ppmw to 10,000 ppmw, from 2,000 ppmw to 3,000 ppmw, from 2,000 ppmw to 4,000 ppmw, from 2,000 ppmw to 5,000 ppmw, from 2,000 ppmw to 6,000 ppmw, from 2,000 ppmw to 10,000 ppmw, from 3,000 ppmw to 4,000 ppmw, from 3,000 ppmw to 5,000 ppmw, from 3,000 ppmw to 6,000 ppmw, from 3,000 ppmw to 10,000 ppmw, from 4,000 ppmw to 5,000 ppmw, from 4,000 ppmw to 6,000 ppmw, from 4,000 ppmw to 10,000 ppmw, from 5,000 ppmw to 6,000 ppmw, or from 5,000 ppmw to 10,000 ppmw of the metal complex 210. In embodiments, the slurry-phase catalyst stream 228 can comprise a concentration of the metal complex 210 that may be greater than a solubility limit of the metal complex 210. Without being bound by any particular theory, it is believed that at concentrations below 100 ppmw, there may be an insufficient amount of the metal complex 210 present in the slurry-phase catalyst stream 228 for a catalytic reaction to proceed, or to proceed at an economical rate. On the contrary, it is believed that the metal complex 210 may not dissolve, or may only partially dissolve in the aromatic bottoms 212 at concentrations above 10,000 ppmw.

Embodiments provided herein can improve the solubility of a metal complex, reduce waste production from an aromatics recovery complex, and improve function and economics of slurry-phase hydrocracking, among others.

According to a first aspect, either alone or in combination with any other aspect, a method of producing a catalyst composition, the method comprising mixing a metal complex and aromatic bottoms, where the aromatic bottoms is a product from an aromatics recovery complex which comprises C₉₊ aromatic compounds; heating the mixture of the metal complex and aromatic bottoms to an elevated temperature sufficient to dissolve or disperse at least a portion of the metal complex in the aromatic bottoms, thereby forming a catalyst precursor composition comprising a liquid component and a solid component; and separating out at least a portion of the solid component from the catalyst precursor composition to produce the catalyst composition comprising the liquid component.

According to a second aspect, either alone or in combination with any other aspect, wherein the metal complex comprises one or more transition metals.

According to a third aspect, either alone or in combination with any other aspect, wherein the transition metal comprises molybdenum, cobalt, nickel, tungsten, iron, chromium or a combination of two or more thereof.

According to a fourth aspect, either alone or in combination with any other aspect, wherein the metal complex comprises bis(acetylacetonato)dioxomolybdenum(VI), molybdenum trioxide, molybdenum hexacarbonyl, or a combination of two or more thereof.

According to a fifth aspect, either alone or in combination with any other aspect, wherein the aromatic bottoms comprises C₉ aromatic hydrocarbons, C₁₀ aromatic hydrocarbons, C₁₁ aromatic hydrocarbons, C₁₁₊ aromatic hydrocarbons, or a combination of two or more thereof.

According to a sixth aspect, either alone or in combination with any other aspect, wherein the aromatic bottoms has a boiling temperature range of from 100° C. to 450° C.

According to a seventh aspect, either alone or in combination with any other aspect, wherein the elevated temperature is from 50° C. to 250° C.

According to an eighth aspect, either alone or in combination with any other aspect, wherein the mixing occurs in a mixing vessel pressurized from 1 bar to autogenous pressure.

According to a ninth aspect, either alone or in combination with any other aspect, wherein at least a portion of the solid component is separated out by introducing the catalyst precursor composition to a solid settling vessel.

According to a tenth aspect, either alone or in combination with any other aspect, further comprising recycling the separated solid component to a mixing vessel comprising the metal complex and the aromatic bottoms.

According to an eleventh aspect, either alone or in combination with any other aspect, a method of hydrocracking comprising hydrocracking a petroleum composition in a slurry-phase hydrocracking unit using the catalyst from the first aspect.

According to a twelfth aspect, either alone or in combination with any other aspect, wherein the slurry-phase hydrocracking unit comprises hydrogen, and wherein the operating conditions of the slurry-phase hydrocracking unit comprise a minimum hydrogen partial pressure of from 5,000 kPa to 25,000 kPa and an operating temperature of from 100° C. to 500° C.

According to a thirteenth aspect, either alone or in combination with any other aspect, wherein the slurry-phase hydrocracking unit comprises a feedstock having an average boiling point temperature of greater than 370° C.

According to a fourteenth aspect, either alone or in combination with any other aspect, a catalyst composition comprising a transition metal complex; and an aromatic bottoms comprising C₉₊ aromatics; wherein the transition metal complex is dissolved or dispersed in the aromatic bottoms.

According to a fifteenth aspect, either alone or in combination with any other aspect, wherein the transition metal complex comprises molybdenum, cobalt, nickel, tungsten, iron, chromium or a combination of two or more thereof.

According to a sixteenth aspect, either alone or in combination with any other aspect, wherein the transition metal complex comprises ligands, organometallics, salts, oxides, sulfides, or combinations thereof.

According to a seventeenth aspect, either alone or in combination with any other aspect, wherein the transition metal complex comprises ligands comprising oxygen groups, and wherein the oxygen groups are bonded to a metal.

According to an eighteenth aspect, either alone or in combination with any other aspect, wherein the transition metal complex comprises bis(acetylacetonato)dioxomolybdenum(VI), molybdenum trioxide, molybdenum hexacarbonyl, or a combination of two or more thereof.

According to a nineteenth aspect, either alone or in combination with any other aspect, wherein the aromatic bottoms comprises C₉ aromatics, C₁₀ aromatics, C₁₁ aromatics, C₁₁+ aromatics, or a combination of two or more thereof.

According to a twentieth aspect, either alone or in combination with any other aspect, wherein the transition metal complex comprises bis(acetylacetonato)dioxomolybdenum(VI) and the aromatic bottoms comprises at least 60 weight percent of monoaromatic hydrocarbons.

### EXAMPLES

The various embodiments disclosed herein will be further clarified by the following examples. The examples are illustrative in nature, and should not be understood to limit the embodiments disclosed herein.

### Example 1. Composition of Aromatic Bottoms from Aromatics Recovery Complex

Properties of an exemplary aromatic bottoms from an aromatics recovery complex are shown in Table 1.

TABLE 1

| Property/Composition | Unit | Value |
|---|---|---|
| Density | kg/L | 0.873 |
| Initial boiling point | ° C. | 21 |
| 5 wt. % boiling point | ° C. | 36 |
| 10 wt. % boiling point | ° C. | 34 |
| 30 wt. % boiling point | ° C. | 58 |
| 50 wt. % boiling point | ° C. | 98 |
| 70 wt. % boiling point | ° C. | 138 |
| 90 wt. % boiling point | ° C. | 168 |
| 95 wt. % boiling point | ° C. | 181 |
| Final boiling point | ° C. | 207 |
| Paraffins | wt. % | 0.16 |
| Monoaromatics | wt. % | 69.83 |
| Naphtheno monoaromatics | wt. % | 1.07 |
| Diaromatics | wt. % | 23.63 |
| Naphtheno diaromatics | wt. % | 2.49 |
| Triaromatics | wt. % | 1.33 |
| Naphtheno triaromatics | wt. % | 0.78 |
| Tetraaromatics | wt. % | 0.15 |
| Naphtheno tetraaromatics | wt. % | 0.15 |
| Pentaaromatics | wt. % | 0.42 |

### Example 2. Solubility of Molybdenum Complex

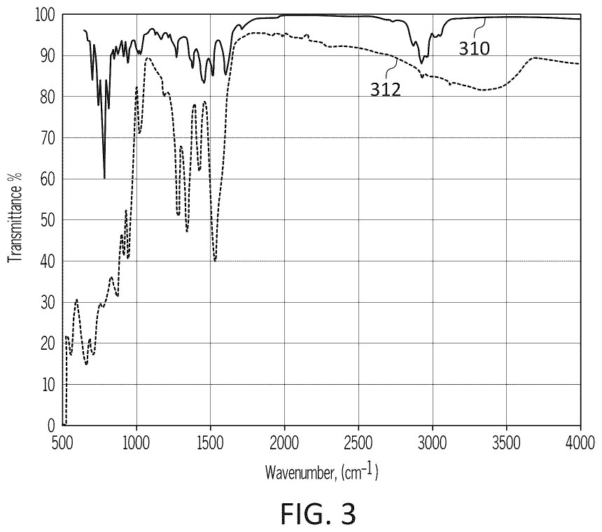

The solubility of bis(acetylacetonato)dioxomolybdenum(VI) (Mo complex) in the aromatic bottoms of Example 1 was evaluated at 185° C. Specifically, 15 g of the Mo complex was added to 50 g of the aromatic bottoms in an Erlenmeyer flask and refluxed at 185° C. for 1 hour. The reflux column was cooled to 5° C. The mixture was cooled to room temperature and filtered through filter paper to separate at least a portion of the solid phase from the liquid phase. The solids were washed with pentane until the filtrate was clear. The solid sample was dried at room temperature for 1 hour, and then at 60° C. to 70° C. for 1 hour. The liquid phase was analyzed using a FT-IR spectrometer. Additionally, the solid Mo complex as a control was analyzed using the FT-IR spectrometer. The FTIR spectra of the Mo complex in the aromatic bottoms 310 and the comparative Mo complex 312 are shown in FIG. 3. As demonstrated in FIG. 3, the Mo complex in the aromatic bottoms 310 spectrum resembles the comparative Mo complex 312 spectrum, indicating the Mo complex is dissolved and dispersed in the aromatic bottoms. The molybdenum concentration of the liquid phase was analyzed using inductively coupled plasma-atomic emission spectroscopy (ICP-AES). The molybdenum concentration of the liquid phase is 2736 ppmw of molybdenum or 9291 ppmw of the Mo complex.

It will be apparent to persons of ordinary skill in the art that various modifications and variations can be made without departing from the scope disclosed herein. Since modifications, combinations, sub-combinations, and variations of the disclosed embodiments, which incorporate the spirit and substance disclosed herein, may occur to persons of ordinary skill in the art, the scope disclosed herein should be construed to include everything within the scope of the appended claims and their equivalents.

For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter. The transitional phrases “consisting of” and “consisting essentially of” may be interpreted to be subsets of the open-ended transitional phrases, such as “comprising” and “including,” such that any use of an open ended phrase to introduce a recitation of a series of elements, components, materials, or steps should be interpreted to also disclose recitation of the series of elements, components, materials, or steps using the closed terms “consisting of” and “consisting essentially of.” For example, the recitation of a composition “comprising” components A, B, and C should be interpreted as also disclosing a composition “consisting of” components A, B, and C as well as a composition “consisting essentially of” components A, B, and C. Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

It should be understood that any two quantitative values assigned to a property may constitute a range of that property, and all combinations of ranges formed from all stated quantitative values of a given property are contemplated in this disclosure. The subject matter disclosed herein has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

What is claimed is:

1. A method of producing a catalyst composition, the method comprising:
mixing a metal complex and aromatic bottoms, where the aromatic bottoms is a product from an aromatics recovery complex which comprises C₉+ aromatic compounds;
heating the mixture of the metal complex and aromatic bottoms to an elevated temperature sufficient to dissolve or disperse at least a portion of the metal complex in the aromatic bottoms, thereby forming a catalyst precursor composition comprising a liquid component and a solid component; and
separating out at least a portion of the solid component from the catalyst precursor composition to produce the catalyst composition comprising the liquid component.

2. The method of claim 1, wherein the metal complex comprises one or more transition metals.

3. The method of claim 2, wherein the transition metal comprises molybdenum, cobalt, nickel, tungsten, iron, chromium or a combination of two or more thereof.

4. The method of claim 1, wherein the metal complex comprises bis(acetylacetonato)dioxomolybdenum(VI), molybdenum trioxide, molybdenum hexacarbonyl, or a combination of two or more thereof.

5. The method of claim 1, wherein the aromatic bottoms comprises C₉ aromatic hydrocarbons, C₁₀ aromatic hydrocarbons, C₁₁ aromatic hydrocarbons, C₁₁₊ aromatic hydrocarbons, or a combination of two or more thereof.

6. The method of claim 1, wherein the aromatic bottoms has a boiling temperature range of from 100° C. to 450° C.

7. The method of claim 1, wherein the elevated temperature is from 50° C. to 250° C.

8. The method of claim 1, wherein the mixing occurs in a mixing vessel pressurized from 1 bar to autogenous pressure.

9. The method of claim 1, wherein at least a portion of the solid component is separated out by introducing the catalyst precursor composition to a solid settling vessel.

10. The method of claim 9, further comprising recycling the separated solid component to a mixing vessel comprising the metal complex and the aromatic bottoms.

11. A method of hydrocracking comprising:
hydrocracking a petroleum composition in a slurry-phase hydrocracking unit using the catalyst from claim 1.

12. The method of claim 11, wherein the slurry-phase hydrocracking unit comprises hydrogen, and wherein the operating conditions of the slurry-phase hydrocracking unit comprise a minimum hydrogen partial pressure of from 5,000 kPa to 25,000 kPa and an operating temperature of from 100° C. to 500° C.

13. The method of claim 11, wherein the slurry-phase hydrocracking unit comprises a feedstock having an average boiling point temperature of greater than 370° C.

14. A catalyst composition comprising:
a transition metal complex; and
an aromatic bottoms comprising C₉+ aromatics; wherein:
the transition metal complex is dissolved or dispersed in the aromatic bottoms.

15. The composition of claim 14, wherein the transition metal complex comprises molybdenum, cobalt, nickel, tungsten, iron, chromium or a combination of two or more thereof.

16. The composition of claim 14, wherein the transition metal complex comprises ligands, organometallics, salts, oxides, sulfides, or combinations thereof.

17. The composition of claim 14, wherein the transition metal complex comprises ligands comprising oxygen groups, and wherein the oxygen groups are bonded to a metal.

18. The composition of claim 14, wherein the transition metal complex comprises bis(acetylacetonato)dioxomolybdenum(VI), molybdenum trioxide, molybdenum hexacarbonyl, or a combination of two or more thereof.

19. The composition of claim 14, wherein the aromatic bottoms comprises C₉ aromatics, C₁₀ aromatics, C₁₁ aromatics, C₁₁+ aromatics, or a combination of two or more thereof.

20. The composition of claim 14, wherein the transition metal complex comprises bis(acetylacetonato)dioxomolybdenum(VI) and the aromatic bottoms comprises at least 60 weight percent of monoaromatic hydrocarbons.
